(19) United States
(12) Patent Application Publication
(10) Pub. No.: US 2022/0288844 A1
(43) Pub. Date: Sep. 15, 2022

(54) TREATMENT OF FUSED BUILD MATERIALS

(71) Applicant: HEWLETT-PACKARD DEVELOPMENT COMPANY, L.P., Spring, TX (US)

(72) Inventors: Cristian Ferris Roig, Sant Cugat del Valles (ES); Julia Almacellas Visa, Sant Cugat del Valles (ES); Marc Borras Camarasa, Sant Cugat del Valles (ES); Davinia Font Calafell, Sant Cugat del Valles (ES)

(21) Appl. No.: 17/637,657

(22) PCT Filed: Sep. 24, 2019
(86) PCT No.: PCT/US2019/052597

§ 371 Date: Feb. 23, 2022

(51) Int. Cl. B29C 64/194; B29C 64/393; B29C 64/153; B29C 64/277

(52) U.S. Cl. CPC B29C 64/194; B29C 64/393; B29C 64/153; B29C 64/277; B33Y 10/00

(57) ABSTRACT

Methods of treating fused build material in an additive manufacturing system are described. The method includes a first treatment process comprising: depositing unfused build material over the fused build material in a working area of the additive manufacturing system, thereby providing a first build material layer; and supplying energy from a first energy source to the first build material layer to heat but substantially not fuse the unfused build material of the first build material layer. The method also includes a second treatment process comprising: depositing unfused build material over the first build material layer in the working area, thereby providing a second build material layer; and supplying energy from a second energy source to the second build material layer to heat but substantially not fuse the unfused build material of the first and second build material layers.

### BACKGROUND

Additive manufacturing systems, including those commonly referred to as “3D printers”, provide a convenient way to produce three-dimensional objects. These systems may receive a definition of a three-dimensional object in the form of an object model. This object model is processed to instruct the system to produce the object from build material components. This may be performed on a layer-by-layer basis in a working area of the system. Chemical agents, referred to as “printing agents”, may be selectively deposited onto each layer of build material within the working area. In one case, the printing agents may comprise a fusing agent and a detailing agent, among others. Energy may be applied using a radiation source, such as an infrared lamp, to fuse areas of a build material layer where fusing agent has been deposited. The process may be repeated for further layers to build up a final object. Generating objects in three-dimensions presents many challenges that are not present with two-dimensional print apparatus, for example warpage and/or dimensional errors.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIGS. 1A-1C are schematic diagrams showing components of an additive manufacturing system suitable for carrying out a method according to an example;

FIG. 2 is a flow diagram showing a method of treating a three-dimensional object in an additive manufacturing system according to an example;

FIGS. 3A-3B are isometric schematic illustrations of an additive manufacturing system performing part of a method according to an example;

FIG. 4 is a schematic diagram showing a computing device according to an example;

FIG. 5 is bar chart diagram comparing variation of dimensions of fused three-dimensional objects.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In some examples, a method of treating fused material in an additive manufacturing system may comprise a first treatment process and a second treatment process.

In some examples, an additive manufacturing system may be used for carrying out such methods, and may be used to generate a three-dimensional object by selectively fusing portions of a build material. An additive manufacturing system may comprise a print bed (also referred to as a working area), where layers of build material are deposited.

In examples described herein, a print bed (also referred to as a working area) of an additive manufacturing system is defined as an area in which build material is deposited and fused in order to make a three-dimensional object. The working area may comprise a moveable platen, base or platform. An initial layer of build material may be deposited on the moveable platform in the working area, and successive layers of build material deposited on top of the build material in the working area on the moveable platform over the course of production. In some examples, before or after the deposition of each build material layer, the platform advances in a direction (e.g. up or down) to allow for the deposition of further build material.

The additive manufacturing system may also comprise a supply mechanism to deposit layers of build material within the working area. The supply mechanism may comprise at least one of a build material supply, a build material preconditioning system, a build material spreading system, and a power advance system, for example

The build material may be a powder. Powders may be formed from, or may include, short fibers that may, for example, have been cut into short lengths from long strands or threads of material. Powders may also be formed by grinding or milling of a material. The powder may comprise plastics, ceramic, and/or metal. In some examples, the build material may be a metal powder. In some examples, the build material may be a polymer powder (or slurry, paste, gel, etc.). Certain examples described herein are particularly suited to additive manufacturing systems that use a powdered build material. In examples wherein the build material is a powder, the supply mechanism may comprise a powder supply, a powder preconditioning system, a powder spreading system, and a power advance system. The supply mechanism may supply build material to provide a build material layer of substantially uniform thickness in the working area. In an example, the thickness of the build material layer may correspond to the distance between the surface on which the build material layer was deposited and the top of the working area. In use, layers of build material are fused.

The additive manufacturing system may comprise a printing agent deposit mechanism for depositing printing agents onto build material within the working area. The printing agent deposited by the printing agent deposit mechanism may be a composition which can be used to modify a degree of fusing of a portion of build material in a portion of the working area, upon supplying energy to the working area, i.e. a portion on which the printing agent has been deposited. A printing agent may comprise a fusing agent, a detailing agent and/or a functional agent. Where the build material comprises metal powder, a printing agent may comprise binding agent for binding metal particles.

A fusing agent may be applied to a layer of build material to define areas of the layer which should be fused by supplying energy to the build material from an energy source. In an example, the fusing agent may absorb infrared radiation. A fusing agent may comprise carbon black, for example. Similarly, in certain cases, a detailing agent may be applied to areas of a layer of build material, for example to inhibit, or modify a degree of fusing of the build material once energy from an energy source is supplied thereto. In an example, the detailing agent may reflect infrared radiation. A detailing agent may comprise titanium dioxide, for example.

In some examples, the printing agent deposit mechanism may be fixed, or may be movable across the working area (i.e. scan across the working area in one or more directions). The printing agent deposit mechanism may selectively deposit one or more printing agents to portions of the build material in the working area. The printing agent deposit mechanism may comprise a plurality of printheads, each to deposit particular printing agent(s). In another example, the printing agent deposit mechanism may comprise a single printhead die, e.g. which extends across a width or height of the working area.

A suitable additive manufacturing system comprises a first energy source arranged to supply energy to the working area to thereby fuse portions of build material disposed therein. For example, build material as supplied from the supply mechanism to the platform of the working area may be fused, at least in certain areas, to form a fused portion of build material. The first energy source may be mounted above the working area. In certain examples, the first energy source may travel or scan across the working area.

In some examples, the first energy source may comprise one or more energy source suitable for supplying energy to the working area, including but not limited to one or more infrared energy sources, one or more laser sources, etc. In some cases, the first energy source may be configured to, when supplying energy to the working area, substantially fuse build material that has a fusing agent disposed thereupon. That is, if no fusing agent is present, the first energy source does not substantially fuse the build material. However, the build material may be heated.

In one example, the first energy source may provide energy to substantially all of the working area at substantially the same time. For example, the first energy source may be a static energy source. In other examples, the first energy source may provide energy to successive sections of the working area; that is, the first energy source may comprise a scanning source that scans across the working area to provide energy to the working area (for example, if the first energy source is attached to a printing carriage as part of the printing agent deposit mechanism). In both cases, the energy supplied by the first energy source to the working area may be substantially uniform across the working area.

In examples where the first energy source scans across the working area, the cumulative energy applied across the working area after one scan of the first energy source across the whole of the working area may be substantially uniform across the working area. In both cases, the energy absorbed by the build material from the energy source is sufficient to fuse at least a portion of the build material to which a fusing agent has been applied. In some examples, the first energy source may be adjacent to the one or more printheads on the printing carriage of the printing agent deposit mechanism. In some examples, the first energy source comprises an infrared energy source (for example, a short-wave incandescent lamp). In some examples, the first energy source may comprise a halogen lamp.

In some examples, the first energy source may emit radiation across a broad range of wavelengths, the radiation having wavelengths of from about 700 nm to 1 mm, or from 700 nm to 100 μm, or from 750 nm to 5 μm.

In some examples, when the first energy source supplies energy to the working area, build material that has had a fusing agent disposed thereupon experiences a greater rise in temperature compared with a build material that has not had a fusing agent disposed thereupon. For example, the first energy source may supply radiation with a spectral power distribution suited to the absorption characteristics of the fusing agent such that the amount of energy absorbed per unit area of build material is maximized when fusing agent has been applied. In such an example, the radiation may also have a spectral power distribution that is configured to not be suited to the absorption characteristics of unfused build material, such that the amount of energy absorbed per unit area of build material is minimized when fusing agent has not been applied. That is, an area of build material will not be substantially heated by the first energy source unless the fusing agent has been applied.

In some examples, the first energy source may be configured to supply radiation that has a color temperature of from 2300 to 3500 K (degrees Kelvin), 2500 to 3200 K, 2500 to 2900 K for example; spectral power distribution of these color temperatures may be suited to the absorption characteristics of the fusing agent.

The additive manufacturing system comprises a second energy source for supplying energy to portions of the working area. The second energy source may comprise any suitable energy source for supplying energy to at least a portion of the working area (i.e. a portion of the build material on the print bed). In some examples, the second energy source may be configured such that, when supplying energy to build material that has a fusing agent disposed thereupon, the build material does not become substantially fused. In some examples, the second energy source may supply energy uniformly across the whole working area. Alternatively, or additionally, the second energy source may supply energy to specific portions of the working area.

In some examples, the second energy source may comprise an infrared energy source (such as a short-wave incandescent lamp). In some examples, the second energy source may comprise a halogen lamp. The second energy source may, during the fusing of the layers, be used to supply heat to the working area such that portions of the working area are maintained at a predetermined temperature.

The second energy source may be positioned in any suitable way that allows energy to be supplied to build material in the working area (such as mounted above the working area, for example).

In some examples, when the second energy source supplies energy to the working area, build material that has not had fusing agent disposed thereupon experiences a rise in temperature that is substantially equivalent to, or more than, a rise in temperature of a build material that has had a fusing agent disposed thereupon. That is, the application of fusing agent to the build material does not result in a greater rise in temperature when the second energy source supplies energy to the build material, compared with build material that has not been treated with fusing agent.

For example, the second energy source may supply radiation with a spectral power distribution suited to the absorption characteristics of unfused build material such that the amount of energy absorbed per unit area of unfused build material is maximized when fusing agent has not been applied. For example, the second energy source may supply radiation with a spectral power distribution that is configured to not be suited to the absorption characteristics of a fusing agent. That is, the temperature of the fusing agent may not be substantially raised by supplying energy from the second energy source, and so the build material with the fusing agent disposed thereupon does not become fused.

In some examples, the second energy source has a color temperature different from the first energy source, such as a lower color temperature than the first energy source. For example, in some cases, the second energy source may be configured to supply radiation that has a color temperature of from 1200 to 2200 K (degrees Kelvin), 1500 to 2000 K, 1700 to 1900 K for example.

In some examples, the build material may comprise a thermoplastic build material. In some examples, the build material may be a polyamide build material.

In some examples, the build material may be a powder having an average particle size of from 40 to 85 μm, or from 55 to 65 μm. In some examples, the build material may be a powder having a bulk density of from 0.4 to 0.5 g/cm³. In some examples, the build material may be a powder having a powder melting point of from 170 to 210° C.

In some examples, the build material may comprise a polyamide build material such as poly(ω-undecanamide) (sometimes known as nylon 11 or polyamide 11) having the formula [(CH₂)₁₀C(O)NH]ₙ. In one example, the build material may comprise a polyamide build material such as poly(ω-dodecanamide) (sometimes known as nylon 12 or polyamide 12) having the formula [(CH₂)₁₁C(O)NH]ₙ.

In some examples, the build material comprises a polyamide and glass bead particles, the glass bead particles being present in an amount of from 20 to 60 wt. % of the build material.

To help provide three-dimensional objects with high overall part quality (e.g. with limited warpage and/or dimensional errors), in some examples the method may include treating fused build material forming the most recently fused layers of the three-dimensional object. The methods described herein may be performed at the end of a build, i.e. after the three-dimensional object has been completed. In some cases, the methods may be performed immediately after the final layer has been fused. The treatment method may be described as an “annealing process”; that is, in some examples, the energy source may supply energy to, and thereby heat a portion of fused build material to an elevated temperature, for example around its softening temperature (or melting temperature). The portion may then cool gradually, thereby relieving stress in the portion.

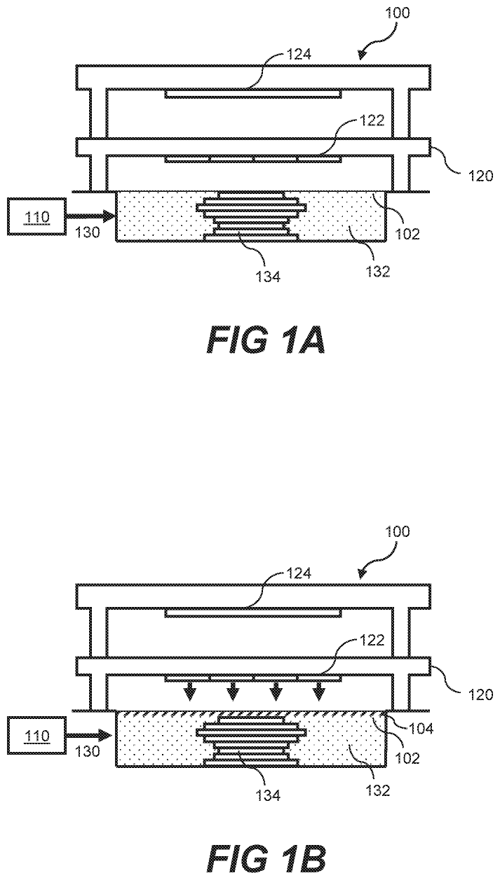

FIGS. 1A-1C illustrate an example additive manufacturing system 100 at each stage of an example method. FIG. 1A shows the additive manufacturing system immediately following fusing of the final layer of the three-dimensional object, and prior to a first treatment process. FIG. 1B shows the additive manufacturing system following a first treatment process described hereinbelow. FIG. 10 shows the additive manufacturing system following a second treatment process described hereinbelow.

In FIG. 1A, the additive manufacturing system 100 is shown comprising a supply mechanism 110 and a printing agent deposit mechanism 120 (shown as a movable printing carriage in FIG. 1), the printing agent deposit mechanism 120 comprising a first energy source 122 for fusing build material (referred to sometimes herein as a fusing lamp). The additive manufacturing system 100 also comprises a second energy source 124 (referred to sometimes herein as a top lamp), positioned above the working area and arranged to supply energy to the working area 130. The working area 130 comprises build material 132 that has not been fused, and build material 134 that has been fused to form a three-dimensional object. In FIGS. 1A to 1C the layer 102 comprises fused build material and unfused material.

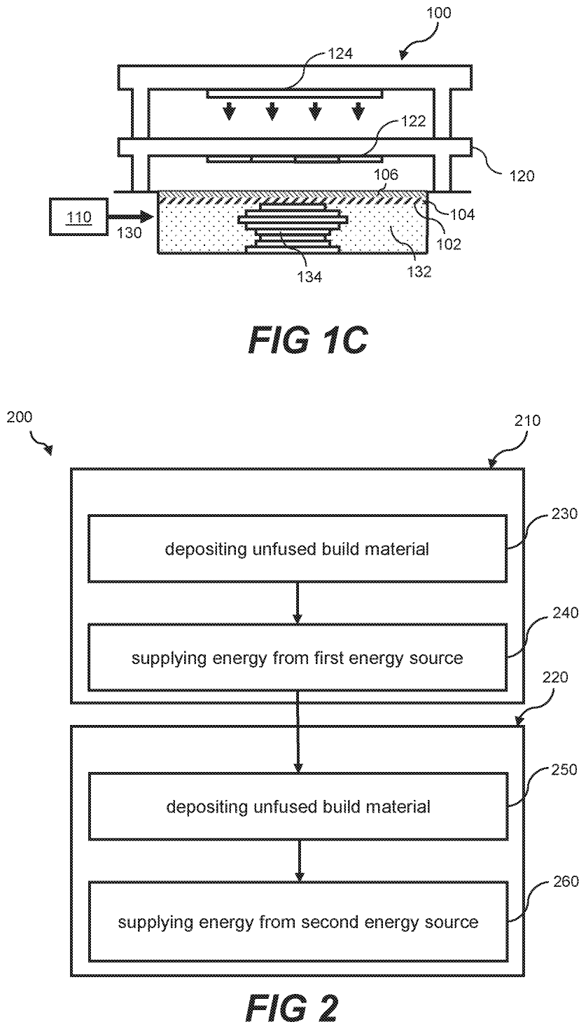

FIG. 2 is a flow diagram showing a method 200 of treating the fused build material of a three-dimensional object. The method 200 comprises the first treatment process 210 and the second treatment process 220. The method may be carried out by the additive manufacturing system shown in FIGS. 1A to 1C—reference may be made to the integers shown in FIGS. 1A to 10 when describing FIG. 2.

At block 210 of FIG. 2, the first treatment process 210 comprises blocks 230 and 240. Block 230 comprises depositing unfused build material over the fused build material in the working area to provide a first build material layer; block 240 comprises supplying energy from a first energy source to the first build material layer to heat but substantially not fuse the unfused build material.

FIG. 1B illustrates the state of an additive manufacturing system immediately after carrying out the first treatment process 210. The arrows shown indicate the direction of the energy being supplied by the fusing lamps 122 during the first treatment process 210.

The unfused build material may be deposited at block 230 by a supply mechanism 110 as shown in FIG. 1B. The first energy source which supplies energy at block 240 may be a fusing lamp 122 as shown in FIG. 1B. That is, the first energy source may be the same energy source used to fuse build material during fusing of the three-dimensional object.

The deposited unfused build material that provides the first build material layer 104 may cover the entire working area (for example to form a layer of uniform thickness across the working area) thus covering the last fused layer 102, i.e. both the fused build material 134 of the three-dimensional object and other build material 132 from previous layers that has not been fused. In FIG. 1B the first build material layer 104 has been deposited by the supply mechanism 110 and forms a substantially uniform layer of unfused build material over the working area. Once deposited, the first build material layer 104 may have a thickness that is determined based upon user input data, the type of build material, the properties of the build material, the object to be fused, or the size of the printing volume in the additive manufacturing system. The thickness of the or each first build material layer 104 may be from 20 μm to 200 μm, 40 μm to 150 μm, 50 μm to 120 μm, or 70 to 100 μm for example. In some examples, at block 230, and throughout the first treatment process 210, no fusing agent is applied, deposited or added to the unfused build material in the first build material layer 104.

After the first build material layer 104 has been formed, the first treatment process 210 comprises supplying energy from a first energy source to the first build material layer 240. The first energy source may correspond to the first energy source described hereinabove; in FIG. 1A to 1C the first energy source is also the fusing lamp 122, that was used during fusing of the three-dimensional object. In some examples, the first energy source may supply infrared radiation. In some examples, the first energy source may comprise a halogen lamp.

The first energy source 122 may supply radiation to the working area that has a specific color temperature. For example, in some cases, the first energy source 122 may be configured to supply radiation that has a color temperature of from 2300 to 3500 K (degrees Kelvin), 2500 to 3200 K, 2500 to 2900 K for example. The first energy source 122 may be configured to fuse build material that has a fusing agent disposed thereupon, and may have been used to fuse build material during fusing of the layers of the three-dimensional object. However, the unfused build material remains substantially unfused when supplying energy from the first energy source 122 at block 240. For example, no fusing agent is deposited on the first build material layer 104 during the first treatment process 210 so that the unfused build material does not fuse when supplied with energy from the first energy source 122.

In some examples, the first treatment process 210 is carried out more than once. The number of times that the first treatment process 210 is carried out may be determined based on one or more properties of the build material. In some examples, a look-up table that defines how many times the first treatment process 210 should be repeated for each build material is used to determine the number of times the first treatment process 210 is carried out. In some examples, the first treatment process may be carried out from 10 to 400 times, 10 to 300 times, 10 to 200 times, from 20 to 160 times, from 25 to 135 times, for example.

In some examples, the build material used may be a polyamide build material, such as poly(w-undecanamide) (sometimes known as nylon 11 or polyamide 11) having the formula [(CH₂)₁₀C(O)NH]ₙ, or poly(ω-dodecanamide) (sometimes known as nylon 12 or polyamide 12) having the formula [(CH₂)₁₁C(O)NH]ₙ.

In examples where the build material is poly(ω-undecanamide), the first treatment process 210 may be carried out from 10 to 200 times, 10 to 100 times, from 20 to 80 times, from 25 to 70 times, for example.

In examples where the build material is poly(ω-dodecanamide), the first treatment process 210 may be carried out from 10 to 200 times, from 20 to 160 times, from 25 to 135 times, for example.

In some examples, after carrying out the first treatment process 210 for a predetermined number of times, the total thickness of the first build material layers 104 taken together may be from 0.1 to 20 mm, from 1 to 17 mm, or from 2 to 14 mm. The total thickness may be measured as the distance from the surface of the last fused layer 102 to the surface of the first build material layer 104 in contact with the atmosphere before carrying out the second treatment process 220.

In examples where the build material is poly(w-undecanamide), the total thickness of the first build material layers 104 taken together may be from 0.1 to 10 mm, from 1 to 8mm, or from 2 to 7 mm.

In examples where the build material is poly(ω-dodecanamide), the total thickness of the first build material layers 104 taken together may be from 0.1 to 10 mm, from 1 to 17 mm, or from 2 to 14 mm.

The amount of energy supplied by the first energy source 122 to the first build material layer 104 may be determined based upon the type of build material used. Although the first energy source 122 supplies energy to the first build material layer 104, energy may also be indirectly supplied to layers of fused build material 134 beneath the first build material layer 104. In some examples, the amount of energy supplied to the first build material layer 104 may be equal to the amount of energy supplied to the surface layers of build material that are being fused during fusing of the layers of the three-dimensional object (such as whilst fusing the final layer 102 of the three-dimensional object 134).

In some examples, the amount of energy is determined based upon the melting temperature of the build material. In some examples, the amount of energy may be selected such that the build material is heated to a temperature less than the melting temperature of the build material, such as from 1 to 50° C. less, 1 to 30° C. less than the melting temperature, for example. In some examples, although fusing agents are not applied to the build material during the first treatment process 210, the amount of energy supplied to the first build material layer 104 by the first energy source 122 may be equivalent to an amount of energy for fusing build material that has fusing agent deposited thereupon.

In some examples, to determine the amount of energy to be supplied, a look-up table is used which defines how much energy should be supplied by the first energy source 122 to the first build material layer 104 for the build material deposited in the working area 130. In some examples, to determine the amount of energy to be supplied, a look-up table is used which defines how much energy should be supplied by the first energy source 122 to the first build material layer 104 for the fusing agent used during fusing of the three-dimensional object.

In examples where the build material is poly(ω-undecanamide), the amount of energy supplied by the first energy source 122 to the first build material layer 104 may be such that the temperature of the first energy source is from 130 to 260° C., 150 to 250° C., from 170 to 230° C., from 180 to 210° C.

In examples where the build material is poly(ω-dodecanamide), the amount of energy supplied by the first energy source 122 to the first build material layer 104 may be such that the temperature of the first energy source is from 120 to 220° C., from 140 to 200° C., from 170 to 195° C.

In some examples, during the first treatment process, energy may be supplied to the first build material layer 104 from a second energy source in addition to the energy supplied by the first energy source 122. In some examples, the second energy source which supplies energy at block 240 may be a top lamp 124 as shown in FIGS. 1A to 1C.

By supplying energy from a second energy source, the temperature of the build material across the working area 130 (and the first build material layer 104), may be maintained at a desired temperature to ensure a more uniform temperature profile across the working area. In some cases, the second energy source 124 may supply energy at a temperature of or around the temperature of the energy supplied by the first energy source 122.

In some cases, the second energy source 124 may supply energy to maintain the temperature of the build material layer 104 at a desired temperature whilst the first energy source 122 supplies energy to the first build material layer 104. In some examples where the first energy source 122 is a scanning fusing lamp, movable across the working area, the second energy source 124 may maintain the temperature of build material in areas of the working area 130 that are not being supplied with energy by the first energy source 122.

In some examples, the first energy source 122 may be configured such that the energy that is supplied penetrates further through layers of the build material, when compared to the second energy source 124, for example.

In FIG. 2, after the first treatment process 210, the method 200 comprises a second treatment process 220. FIG. 10 illustrates the state of the additive manufacturing system immediately after carrying out the second treatment process 220. The arrows indicate the direction of the energy being supplied by the top lamps 122 during the second treatment process 220.

At block 220, the second treatment process 220 comprises block 250 and block 260. Block 250 comprises depositing unfused build material in the working area, thereby providing a second build material layer; block 260 comprises supplying energy from the second energy source to the second build material layer to heat but substantially not fuse the unfused build material of the first and second build material layer. The unfused build material may be deposited at block 250 by a supply mechanism 110 as shown in FIG. 1C. The second energy source which supplies energy at block 240 may be a top lamp 122, as shown in FIG. 1C.

The unfused build material that provides the second build material layer 106 is deposited over the first build material layer 104, and may provide a substantially uniform layer of unfused build material. The deposited unfused build material that provides the second build material layer 106 may cover the entire working area (for example to form a layer of uniform thickness across the working area), thus covering the first build material layer 104, the final fused layer 102, and the fused build material 134 of the three-dimensional object, and unfused build material 132 of previous layers.

In FIG. 10, the second build material layer has been deposited by the supply mechanism 110, and forms a substantially uniform layer across the working area 130. Once deposited, the second build material layer 106 may have a thickness that is determined based upon user input data, the type of build material, the properties of the build material, the object to be fused, or the size of the printing volume in the additive manufacturing system. The thickness of the or each second build material layer 106 may be from 20 μm to 200 μm, 40 μm to 150 μm, 50 μm to 120 μm, or 70 to 100 μm for example. In some examples, at block 250, and throughout the second treatment process 210, no fusing agent is applied, deposited or added to the unfused build material in the second build material layer 106.

After the second build material layer 106 has been deposited, the second treatment process 220 comprises supplying energy from a second energy source to the second build material layer. The second energy source may correspond to the second energy source described hereinabove; in FIGS. 1A to 1C the second energy source is shown as the top lamp 124. In some examples, the second energy source 124 may have been used during fusing of the three-dimensional object to supply energy to the working area 130, to maintain at least a portion of the working area at a predetermined temperature during fusing of the layers. In some cases, this may be to pre-heat the unfused build material prior to, during and/or after fusing.

In some examples, the second energy source 124 may supply infrared radiation. In some examples, the second energy source 124 may comprise a halogen lamp. In some examples, the second energy source has a different color temperature to the first energy source, such as a lower color temperature than the first energy source. For example, in some cases, the second energy source may be configured to supply radiation that has a color temperature of from 1200 to 2200 K (degrees Kelvin), 1500 to 2000 K, 1700 to 1900 K for example.

The second build material layer 106 may comprise the same type of build material as the build material which is in the working area 130 and that forms the first build material layer 104.

In some examples, the second treatment process 220 is carried out more than once. The number of times that the second treatment process 220 is carried out may be determined based on one or more properties of the build material. In some examples, a look-up table that defines the number of times the second treatment process 220 should be carried out for each build material is used to determine the number of times the second treatment process 220 may be carried out. In some examples, the second treatment process may be carried out from 40 to 200 times, from 50 to 170 times, from 60 to 145 times, for example. In some examples, the build material used is a polyamide build material, such as poly(ω-undecanamide) (sometimes known as nylon 11 or polyamide 11) having the formula [(CH₂)₁₀(O)NH]ₙ, or poly(ω-dodecanamide) (sometimes known as nylon 12 or polyamide 12) having the formula [(CH₂)₁₁C(O)NH]ₙ.

In examples where the build material is poly(ω-undecanamide), the second treatment process 220 may be carried out from 40 to 200 times, from 50 to 170 times, from 60 to 145 times, for example.

In examples where the build material is poly(w-dodecanamide), the second treatment process 220 may be carried out from 90 to 200 times, from 100 to 170 times, from 120 to 145 times, for example.

In some examples, after carrying out the second treatment process 220 for a predetermined number of times, the total thickness of the second build material layers 106 taken together may be from 3 to 40 mm, from 5 to 30 mm, from 7 to 28 mm. The total thickness may be measured as the distance from the surface of the uppermost first build material layer 104 to the surface of the second build material layer 106 that is in contact with the atmosphere.

In examples where the build material is poly(ω-undecanamide), the total thickness of the second build material layers 106 taken together may be from 1 to 20 mm, from 2 to 17 mm, from 4 to 15 mm, for example.

In examples where the build material is poly(w-dodecanamide), the total thickness of the second build material layers 106 taken together may be from 5 to 20 mm, from 7 to 15 mm, from 9 to 14 mm, for example.

The amount of energy supplied to the second build material layer 106 by the second energy source 124 during the second treatment process 220 may be determined based upon the type of build material used and may be determined based on the properties of the build material. In some examples, the amount of energy supplied by the second energy source 124 is equal to the amount of energy supplied by the second energy source 124 during fusing of the layers of the three-dimensional object.

In some examples, the amount of energy supplied to the second build material layer 106 by the second energy source 124 may be determined based on the melting temperature of the build material. In some examples, the amount of energy may be selected such that the build material is heated to a temperature less than the melting temperature of the build material, such as from 1 to 50° C. less, 1 to 30° C. less than the melting temperature, for example. In some examples, a look-up table that defines how much energy should be supplied by the second energy source 124 to the second build material layer 106 for the build material is used.

In examples where the build material is poly(ω-undecanamide), the amount of energy supplied by the second energy source 124 to the second build material layer 106 may be such that the temperature of the second energy source 124 is from 130 to 260° C., 150 to 250° C., from 170 to 230° C., from 180 to 210° C.

In examples where the build material is poly(ω-dodecanamide), the amount of energy supplied by the second energy source 124 to the second build material layer 106 may be such that the temperature of the second energy source 124 is from 120 to 220° C., from 140 to 200° C., from 170 to 195° C.

In some examples, during the second treatment process 220, energy is not supplied to the working area 130 by the first energy source 122.

In some examples, as shown in FIGS. 1A to 1C, the second energy source 124 supplies constant energy to the working area 130 whilst a supply mechanism 110 deposits unfused build material to the working area 130.

The first treatment process 210 and/or the second treatment process 220 may be carried out more than once. The number of times that the first and second treatment process 210, 220 are carried out may be interdependent, in addition to being dependent upon the properties of the build material. In some cases, a look-up table that defines the number of times that the first and/or second treatment processes 210, 220 should be carried out for the build material is used.

For example, in some cases, when the build material is poly(ω-undecanamide), the first treatment process 210 may be carried out from 30 to 40 times, and the second treatment process 220 may be carried out from 70 to 80 times. In other cases, the first treatment process 210 may be carried out from 30 to 40 times, and the second treatment process 220 may be carried out from 130 to 140 times. In other cases, the first treatment process 210 may be carried out from 60 to 70 times, and the second treatment process 220 may be carried out from 130 to 140 times. In other cases, the first treatment process 210 may be carried out from 60 to 70 times, and the second treatment process 220 may be carried out from 70 to 80 times.

For example, in some cases, when the build material is poly(ω-dodecanamide), the first treatment process 210 may be carried out from 30 to 40 times, and the second treatment process 220 may be carried out from 100 to 110 times. In other cases, the first treatment process 210 may be carried out from 60 to 70 times, and the second treatment 220 process may be carried out from 130 to 140 times. In other cases, the first treatment process 210 may be carried out from 120 to 130 times, and the second treatment process 220 may be carried out from 130 to 140 times.

In some examples, after carrying out the first treatment process 210 and second treatment process 220 for a predetermined number of times, the total thickness of the unfused build material layers 104, 106 taken together may be from 3 to 40 mm, from 5 to 30 mm, from 7 to 28 mm. The thickness being measured as the distance from the surface of the last fused layer 102 to the surface of the second build material layer 104 that is in contact with the air.

In examples where the build material is poly(ω-undecanamide), the total thickness of the unfused build material layers 104, 106 taken together may be from 5 to 25 mm, from 7 to 20 mm.

In examples where the build material is poly(ω-dodecanamide), the total thickness of the unfused build material layers 104, 106 taken together may be from 5 to 40 mm, from 7 to 35 mm, from 9 to 28 mm.

In some examples, the first energy source 122 may be more suitable for supplying energy that penetrates further through build material layers than the second energy source, for example, because the first energy source is situated closer to the build material, or the energy sources are configured to supply different types of energy. A process using the second energy source 124 alone may involve more layers of build material being supplied to the working area to insulate the last fused layers of the three-dimensional object in order to prevent the quick loss of energy than a method including the first treatment process and the second treatment process.

Some of the methods according to examples described herein may provide a process that uses a small amount of build material, so the method is fast and has a small cost, for example.

In some examples, the method 200 comprises a further treatment process that is carried out after the second treatment process 220 (and after any repetitions of the second treatment process), wherein energy is supplied by the second energy source 124 to the second build material layer 106 and gradually decreased over time until the amount of energy supplied by the second energy source 124 correlates to a predetermined amount of energy (or a predetermined temperature of the second build material layer 106).

In some examples, the amount of energy supplied by the top lamp 124 during the further treatment process is gradually decreased in a number of stages, wherein at each stage the power output of the second energy source is substantially constant over a predetermined duration of time. The duration of time may be determined based upon the properties of the build material, and may be determined with a look-up table that defines the amount of time that the energy should be applied for the build material. In some examples, the third treatment process comprises a plurality of stages wherein each stage has a predetermined duration of 1 to 300 seconds, 5 to 200 seconds, 10 to 150 seconds, or 30 to 120 seconds. During each stage, the power output of the second energy source may be substantially constant.

In some examples, the amount of energy supplied to the second build material layer during a first stage is determined based upon the properties of the build material, and in some cases, the melting temperature of the build material. The amount of energy supplied may be such that the temperature of the second build material layer 106 may be, for example, within about 30° C., 20° C. or 10° C. of the melting temperature of the build material.

In some examples, when the build material is poly(ω-undecanamide), the first stage of the further treatment process may comprise supplying energy from the second energy source 124 at a temperature of from 130 to 260° C., 150 to 250° C., from 170 to 230° C., from 180 to 210° C., for example. In some examples, the build material may be poly(ω-undecanamide) having a powder melting point of around 202° C., and the amount of energy supplied to the build material layer is selected such that the temperature of the second build material layer is within about 30° C., 20° C. or 10° C. of the melting temperature of the build material.

In some examples, when the build material is poly(ω-dodecanamide), the first stage of the further treatment process may comprise supplying energy from the second energy source 124 at a temperature of from 120 to 220° C., from 140 to 200° C., from 170 to 195° C., for example. In some examples, the build material may be poly(ω-dodecanamide) having a powder melting point of around 187° C., and the amount of energy supplied to the build material layer is selected such that the temperature of the second build material layer is within about 30° C., 20° C. or 10° C. of the melting temperature of the build material.

Subsequent stages may involve supplying a constant amount of energy to the second build material layer(s), at progressively lower amounts of energy compared to the preceding stage, until a predetermined amount of energy is reached. In some examples, this predetermined amount of energy is determined based upon the properties of the build material, and may be to set up the object for a subsequent treatment, such as a cooling treatment, for example.

In some examples, the amount of energy that is supplied to the second build material layer during the final stage may be determined based upon the crystallization onset temperature of the build material. In some cases, the amount of energy may be within 40° C., or within 20° C. of the crystallization onset temperature of the build material. In some examples, the amount of energy may be from 100 to 200° C., or 140 to 180° C., for example.

In some examples, when the build material is poly(ω-undecanamide), the final stage of the further treatment process may comprise supplying energy from the second energy source 124 at a temperature of from 100 to 200° C., from 120 to 180° C., or from 140 to 170° C., for example.

In some examples, when the build material is poly(ω-dodecanamide), the final stage of the further treatment process may comprise supplying energy from the second energy source 124 at a temperature of from 100 to 200° C., from 130 to 190° C., 150 to 180° C., for example.

In some examples, this further treatment process may involve from 1 to 10, 2 to 8, or 2 to 5 stages. In some cases, the increment by which the amount of energy is lowered at each stage may be determined based upon the properties of the build material: some build materials may suit a more gradual reduction in energy than others. In some examples, a look-up table that defines the amount of energy that should be supplied at each stage for the build material may be used; it may also define the number of stages that should be employed, or the duration of time for each stage.

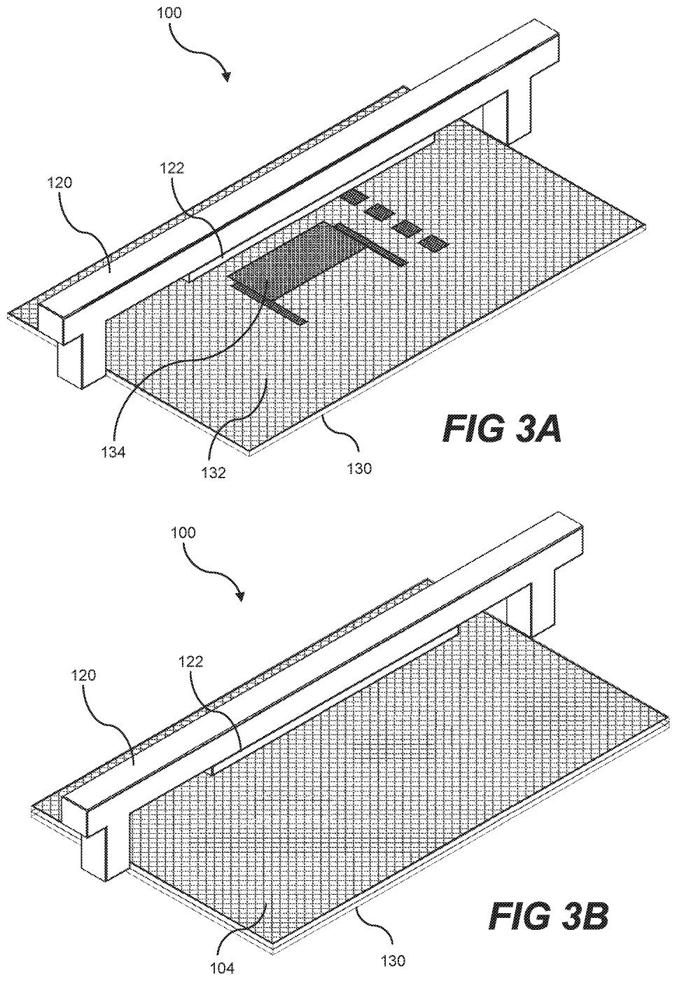

FIGS. 3A-3B are isometric schematic illustrations of the additive manufacturing system shown in FIGS. 1A to 1C performing part of a method according to an example (the top lamp 124 is not shown in this Figure for clarity). FIG. 3A shows the additive manufacturing system immediately following fusing of the final layer of a three-dimensional object. FIG. 3B shows the additive manufacturing system after the first treatment process has been carried out. The first build material layer 104 has been deposited over the fused build material 134 of the three-dimensional object and the unfused build material 132 of the final layer. The fusing lamp 122 (here shown located on the printing carriage 120) may then supply energy to the first build material layer (here by scanning across the width of the working area on the printing carriage 120).

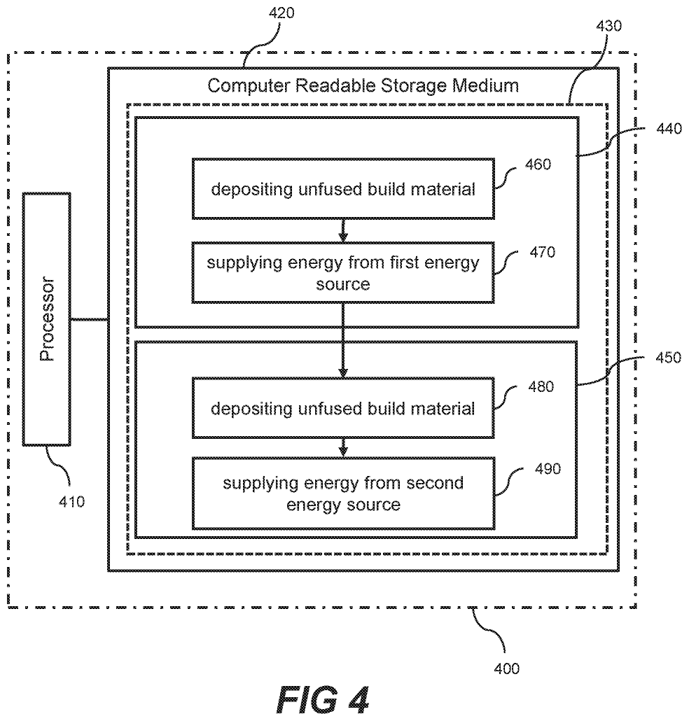

FIG. 4 is a schematic diagram showing a computing device 400 according to an example. The computing device 400 comprises a processor 410. According to one example, there is provided a non-transitory computer-readable storage medium 420 comprising a set of computer-readable instructions 430 stored thereon comprising a first sub-set of instructions 440 and a second sub-set of instructions 450, which, when executed by a processor 410 of an additive manufacturing system, cause the processor to carry out a number of operations.

In FIG. 4, the instructions 430 comprise a first sub-set of instructions 440. At block 460, when the first sub-set of instructions is executed by a processor 410, the processor instructs a supply mechanism (such as the build material supply mechanism described hereinabove and supply mechanism 110 shown in FIGS. 1 and 3) to deposit unfused build material in a working area of an additive manufacturing system, thereby providing a first build material layer. The first build material layer may correspond to a first build material layer described hereinabove. The build material may be deposited over fused build material, such as a finished three-dimensional object, arranged in the working area. At block 470, when the first sub-set of instructions is executed by a processor 410, the processor instructs a first energy source (such as a first energy source described hereinabove, and fusing lamp 122 shown in in FIGS. 1 and 3) to supply energy to the build material of the first build material layer.

The computer-readable instructions 430 also comprise a second sub-set of instructions 450. At block 480, when the second sub-set of instructions is executed by the processor 410 the processor to instruct the supply mechanism (such as the build material supply mechanism 110 shown in FIGS. 1 and 3) to deposit unfused build material in the working area of the additive manufacturing system, thereby providing a second build material layer over the first build material layer. At block 490, when the second sub-set of instructions is executed by the processor 410, the processor instructs a second energy source (such as a second energy source described hereinabove, and top lamp 124 shown in FIGS. 1 and 3) to supply energy to the build material of the second build material layer.

In some examples, the computer-readable instructions comprise further instructions, which, when executed by the processor of the additive-manufacturing, cause the processor to: receive build material information identifying the build material; and determine an amount of energy to be supplied to the working area based on the identity of the build material; wherein the instructions to the first energy source and/or second energy source are based on the determined amount of energy.

In some examples, the processor may receive the build material information from the output of a sensor. In some examples, determining the amount of energy to be supplied may comprise consulting a lookup table that defines the amount of energy to be supplied for the build material.

In some examples, the computer-readable instructions comprise further instructions, which, when executed by the processor of the additive manufacturing system, cause the processor to: receive build material information identifying the build material; determine the number of first build material layers and second build material layers to be provided by the supply mechanism, based on the identity of the build material; execute the first sub-set of instructions one or more times until the predetermined number of first build material layers is deposited; and execute the second sub-set of instructions one or more times until the predetermined number of second build material layers is deposited.

In some examples, the processor may receive the build material information from the output of a sensor. In some examples, determining the number of first build material layers and/or second build material layers to be provided by the supply mechanism may comprise consulting a lookup table that defines the number of first build material layers and/or second build material layers to be supplied for the build material.

Each of the features described hereinabove in relation to the method are explicitly disclosed in combination with each of the features described in relation to the non-transitory computer-readable storage medium, and vice versa.

In some examples, when employing the treatment process described herein, a three-dimensional object may be produced by an additive manufacturing system, wherein the width of the last fused layer differs from a width of the corresponding layer of a computer object model defining the three-dimensional object by 10% or less, 7% or less, 5% or less, 2% or less or 1% or less. In some examples, there is provided a three-dimensional object obtainable from the methods described herein.

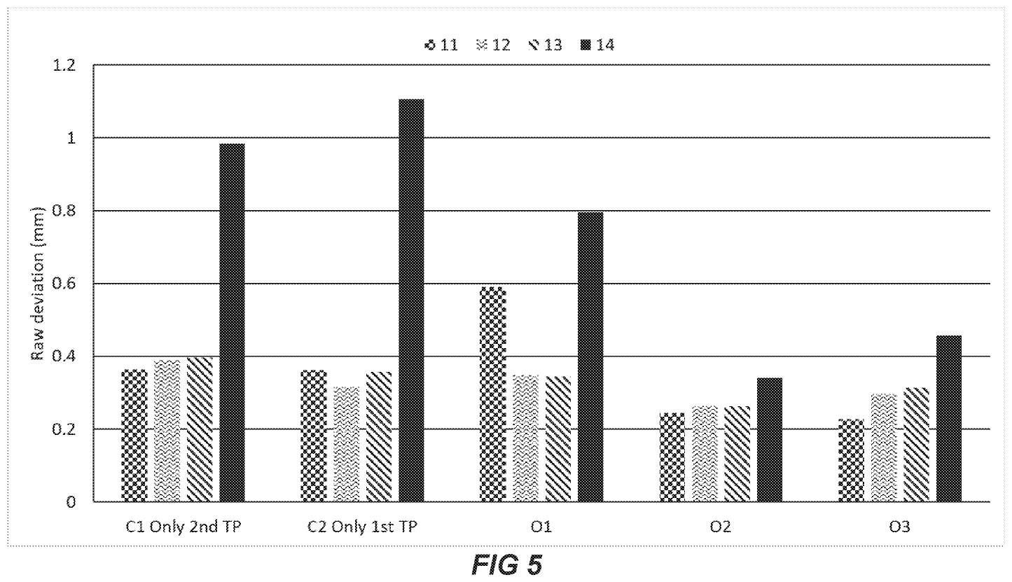

FIG. 5 is a bar chart diagram showing comparative tests of methods of treating fused build material. FIG. 5 demonstrates the raw deviation (mm) of the measurements of a three-dimensional object from the Computer Aided Design (CAD) model used to instruct the additive manufacture of the three-dimensional object, for example by measuring a width of the fused layer. Layers 11 to 14 refer to the top fused layers of the three-dimensional object, wherein layer 14 is the most recently fused layer, and layers 11-13 are the preceding fused layers. The tests were carried out using poly(ω-dodecanamide) as the build material.

All of the tests performed in FIG. 5 included a final process of supplying energy from the top lamp to the build material layers and gradually reducing the temperature in three stages to a predetermined temperature.

C1 is a test that uses the second treatment process alone (i.e. the top lamp 124); C2 is a test that uses the first treatment process alone (i.e. the fusing lamp 122).

O1, O2 and O3 include both the first and second treatment processes as described hereinabove according to an example. Each of the first and second treatment processes in O1 to O3 were carried out a number of times to provide a plurality of first build material layers and second build material layers, the number of which may be suitable for treating fused poly(ω-dodecanamide).

Table 1 below shows the number of times the first and second treatment processes were carried out for the tests shown in FIG. 5.

| | Number of times the first | Number of times the |
|---|---|---|
| | treatment process was | second treatment process |
| Test | carried out | was carried out |
| C1 | 0 | 134 |
| C2 | 108 | 0 |
| O1 | 32 | 104 |
| O2 | 125 | 134 |
| O3 | 62 | 134 |

Tests O1, O2 and O3 resulted in the top layers (14) of the three-dimensional object having measurements that have a small raw deviation from the measurements of the object model. O1 has a deviation in the top layer of about 0.8 mm; O2 and O3 have a deviation of about 0.35 mm and 0.45 mm in the top layer, respectively. In contrast, there was a raw deviation of roughly 1.0 mm in the top layer of the C1 and C2 treatment processes.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of treating fused build material in an additive manufacturing system, the method comprising:
a first treatment process comprising:
depositing unfused build material over the fused build material in a working area of the additive manufacturing system, thereby providing a first build material layer; and
supplying energy from a first energy source to the first build material layer to heat but substantially not fuse the unfused build material of the first build material layer;
and
a second treatment process comprising:
depositing unfused build material over the first build material layer in the working area, thereby providing a second build material layer; and
supplying energy from a second energy source to the second build material layer to heat but substantially not fuse the unfused build material of the first and second build material layers.

2. A method according to claim 1, comprising a third treatment process following the second treatment process, the third treatment process comprising:
supplying energy from the second energy source to the second build material layer, wherein the amount of energy supplied to the second build material layer is gradually decreased until the amount of energy supplied corresponds to a predetermined temperature.

3. A method according to claim 1, wherein the first treatment process and/or second treatment process is carried out more than once.

4. A method according to claim 3, wherein the number of times the first treatment process and/or second treatment process is carried out is determined based on the properties of the build material.

5. A method according to claim 4, wherein the number of times that the first treatment process and/or second treatment process is carried out is determined through using a look-up table which defines the number of times the first treatment process and/or second treatment process should be carried out for the build material.

6. A method according to claim 1, wherein the or each first build material layer and/or the or each second build material layer has a thickness of from 20 μm to 200 μm.

7. A method according to claim 1, wherein the amount of energy supplied to the or each first build material layer and/or the or each second build material layer is determined based on the properties of the build material.

8. A method according to claim 1, wherein the first energy source is configured to substantially fuse build material when supplying energy to build material with a fusing agent disposed thereupon.

9. A method according to claim 1, wherein the second energy source is configured to substantially not fuse build material when supplying energy to build material with a fusing agent disposed thereupon.

10. A method according to claim 1, wherein the first energy source and/or second energy source are infrared energy sources.

11. A method according to claim 1, wherein the first treatment process comprises supplying energy from the second energy source to the first build material layer.

12. A non-transitory computer-readable storage medium comprising a set of computer-readable instructions stored thereon, the computer-readable instructions comprising:
a first sub-set of instructions, which, when executed by a processor of an additive manufacturing system, cause the processor to:
instruct a supply mechanism to deposit unfused build material in a working area of the additive manufacturing system, thereby providing a first build material layer; and
instruct a first energy source to supply energy to the first build material layer to heat but substantially not fuse the unfused build material of the first build material layer;
and
a second sub-set of instructions, which, when executed by the processor of the additive manufacturing system, cause the processor to:
instruct the supply mechanism to deposit unfused build material in the working area, thereby providing a second build material layer over the first build material layer, and
instruct a second energy source to supply energy to the second build material layer to heat but substantially not fuse the unfused build material of the first and second build material layers.

13. A non-transitory computer-readable storage medium according to claim 12, wherein the computer-readable instructions comprise further instructions which, when executed by the processor of the additive-manufacturing system, cause the processor to:
receive build material information identifying the build material; and
determine an amount of energy to be supplied to the working area based on the identity of the build material;
wherein the instructions to the first energy source and/or second energy source are based on the determined amount of energy.

14. A non-transitory computer-readable storage medium according to claim 12, wherein the computer-readable instructions comprise further instructions which, when executed by the processor of the additive-manufacturing system, cause the processor to:
receive build material information identifying the build material;
determine the number of first build material layers and second build material layers to be provided by the supply mechanism, based on the identity of the build material;
execute the first sub-set of instructions one or more times until the predetermined number of first build material layers is deposited; and
execute the second sub-set of instructions one or more times until the predetermined number of second build material layers is deposited.

15. A three-dimensional object produced by an additive manufacturing system based on a computer object model defining the three-dimensional object, the three-dimensional object comprising a plurality of fused layers each having a width, wherein the width of the last-fused layer of the three-dimensional object differs from the width of the corresponding layer of the computer object model by less than 10%.
